(19) United States
(12) Patent Application Publication
(10) Pub. No.: US 2009/0244600 A1
(43) Pub. Date: Oct. 1, 2009

(54) BILLING AND REMITTANCE PAYMENT SYSTEM

(76) Inventors: Todd Haycock, Buford, GA (US); April R. Sumner, Tampa, FL (US); Jeffrey B. Klaasen, Garden Grove, CA (US); Tracy A. Dalton, Tucker, GA (US); Brian Mulford, Novato, CA (US)

Correspondence Address: BLANK ROME LLP, WATERGATE, 600 NEW HAMPSHIRE AVENUE, N.W., WASHINGTON, DC, 20037, US

(21) Appl. No.: 12/324,043

(22) Filed: Nov. 26, 2008

Related U.S. Application Data
(60) Provisional application No. 61/049,399, filed on Apr. 30, 2008.
(60) Provisional application No. 60/990,503, filed on Nov. 27, 2007.

(51) Int. Cl. G06Q 30/00; G06Q 20/00; G06F 17/30; G06F 17/40; G06F 3/048; G06F 3/12

(52) U.S. Cl. 358/1.15; 705/34; 705/40; 707/104.1; 715/764; 707/100; 715/760; 707/E17.019; 707/E17.044

(57) ABSTRACT

A system and a computer program product process billing documents and payments. The system includes one or more processors for processing billing documents and for processing payments, and one or more databases in communication with the one or more processors. The one or more databases store information generated by the one or more processors. The computer program product enables a computer system to process billing documents and payments. The computer system has a computer readable storage medium bearing software instructions. The computer program product has software instructions for enabling the computer system to perform predetermined operations, and the predetermined operations include: providing print rules that control the production of billing documents; providing remittance rules that control processing of the payments; and storing images related to the billing documents and the payments.

### CROSS-REFERENCE TO RELATED APPLICATIONS

This application claims priority to provisional application Ser. No. 60/990,503, filed Nov. 27, 2007, and provisional application Ser. No. 61/049,399, filed Apr. 30, 2008, the contents of which are incorporated herein by reference.

### FIELD OF THE INVENTION

The present invention relates to systems for administering billings and payments. In particular, the present invention relates to systems for preparing, generating, processing, and delivering billing documents and for receiving and processing payments.

### BACKGROUND OF THE INVENTION

Systems for billing and for processing payments are typically operated separately by different providers. In addition, these separately operated systems are not designed to operate with each other and thus do not work together. Thus, billing and payment processing are necessarily separate processes that do not operate in conjunction. Also, users of these systems have different requirements for billing and payment processing. Thus, individualized software applications for controlling billing and payment processing by these systems must be created to meet the requirements of each user. Because individualized software applications are created for each user, any desired changes to billing or payment processing requires a programmer to manually reprogram the software application to implement those changes. Manually reprogramming software applications consumes time and resources. Also, these known systems lack flexibility and do not offer users control over billing and payment processing.

Thus, there is a need for an invention that quickly and easily allows users to control and change billing and payment processing. Specifically, there is a need for an invention that utilizes a Web-based interface to a common platform that enables the users to: (a) generate rules to affect the printing of billing documents; (b) identify and select individual billing documents or groups of billing documents to pull from printing or route to a specific mailing location; (c) review electronically and update selected individual billing documents or groups of billing documents with a disposition status; (d) establish rules to affect payment processing; (e) view and approve or deny payments not automatically processed or determine specific deposit instructions; and (f) retrieve stored images related to billing documents or payments from a single repository and view those images through a single interface.

### SUMMARY OF THE INVENTION

Accordingly, it is an object of the invention to provide a system to process billing documents and payments. It is a further object of the invention to provide a system that integrates billing and payment remittance operations.

An exemplary embodiment of the invention provides a system that includes one or more processors for processing billing documents and for processing payments, and one or more databases in communication with the one or more processors. The one or more databases store information generated by the one or more processors.

Another embodiment of the invention provides a computer program product for enabling a computer system to process billing documents and payments. The computer system has a computer readable storage medium bearing software instructions. The computer program product has software instructions for enabling the computer system to perform predetermined operations, and the predetermined operations include: providing print rules that control the production of billing documents; providing remittance rules that control processing of the payments; and storing images related to the billing documents and the payments.

Yet another embodiment of the invention provides a computer program product for enabling a computer system to process billing documents and payments. The computer system has a computer readable storage medium bearing software instructions. The computer program product has software instructions for enabling the computer system to perform predetermined operations, and the predetermined operations include: communicating through an Internet interface with a system in communication with printing hardware and a payment processor; providing billing data to the system in communication with the printing hardware and the payment processor; establishing print rules that control the production of billing documents by the printing hardware; and establishing remittance rules that control processing of the payments by the payment processor.

Other objects, advantages and salient features of the invention will become apparent from the following detailed description, which, taken in conjunction with the annexed drawings, discloses an embodiment of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a system in accordance with an exemplary embodiment of the invention;

FIG. 2 is a schematic of a software architecture for controlling the system illustrated in FIG. 1;

FIG. 3 is a schematic of an application stack for the software architecture illustrated in FIG. 2;

FIGS. 4a and 4b are a flowchart of billing document printing and payment processing of the system illustrated in FIG. 1;

FIG. 5 is a flowchart of operations performed by a rules module of the system illustrated in FIG. 1;

FIG. 6 is a flowchart of operations performed by a print stream routing module of the rules module illustrated in FIG. 5;

FIG. 7 is a flowchart for the application of remittance rules by the system illustrated in FIG. 1;

FIGS. 8a and 8b are a flowchart of operations performed by a payment decision module of the system illustrated in FIG. 1; and

FIG. 9 is flowchart of operations performed by an image database of the system illustrated in FIG. 1.

### DETAILED DESCRIPTION OF THE INVENTION

In describing an embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

Also, for purposes of illustrating the invention without intending to limit the claims or the invention, the following terms are used herein as described. A “biller” generally refers to an entity that issues bills or invoices to its customers and typically receives payments from its customers. The payment can be received in a physical or electronic lockbox. The biller can conduct bill printing and remittance processing or can purchase those services from a vendor. A “vendor” is generally used to refer to an entity that conducts bill printing or remittance processing, usually on behalf of a biller. A “customer” is an entity or individual that purchases the biller's products or services. The customer receives a bill from the biller or the vendor and remits a payment to the biller or the vendor. An “outside system” refers to a separate computer system that exists outside of the invention.

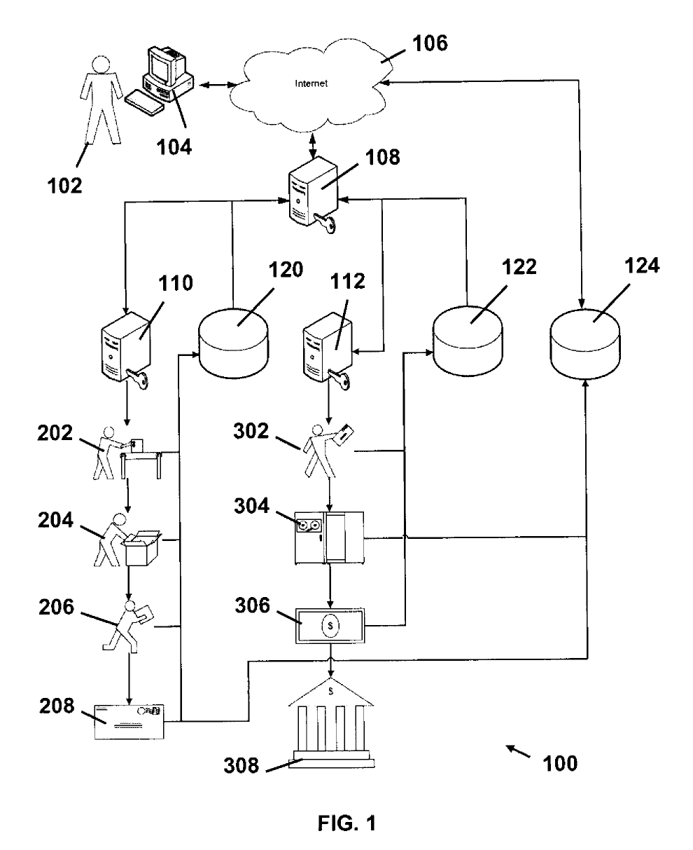

Referring to FIG. 1, a system 100 is shown in accordance with an embodiment of the invention. The system 100 integrates billing and payment processing, produces and manages billing documents 208, processes payments, and provides control over billing and payment processing. The system 100 also stores images related to billing documents 208 and payments. The system 100 can compare incoming payments to their original corresponding billing documents 208.

The system 100 provides increased control over the preparation, processing, generation, and delivery of billing documents 208. The system 100 allows customization of the production, content, and delivery of all billing documents 208 or a portion of the billing documents 208 through global and biller-specific print rules. The system 100 allows users 102 to review an electronic version of the billing document 208 before it is printed or mailed. Thereafter, the billing document 208 can be suppressed, duplicated, or modified. The user 102 can also specify additional processing instructions or modify existing processing instructions, such as the method or manner of delivery of the billing documents 208.

Additionally, the system 100 provides increased control over the processing of payments, including how payments are applied and deposited. When payments are received, the system 100 acquires data from the payments that is compared against the customer account. The system 100 applies remittance rules to process the payment for further handling in case of underpayment, overpayment, and other situations. If the system 100 cannot apply the remittance rules, the system 100 sends the payment to the user 102 for review.

Also, the system 100 quickly and easily allows users 102 to change and control billing document production and payment processing. The system 100 utilizes a Web-based interface 104 to a common platform, enabling users to: (a) generate rules to affect the printing of billing documents 208; (b) identify and select individual billing documents 208 or groups of billing documents 208 to pull from printing or route to a specific mailing location; (c) review electronically and update selected individual billing documents 208 or groups of billing documents 208 with a disposition status; (d) establish rules to affect payment processing; (e) view and approve or deny payments not automatically processed or determine specific deposit instructions; and (f) retrieve stored images related to billing documents 208 or payments from a single repository and view those images through a single interface 104. These features provide better ease-of-use and control compared to systems that separately print billing documents 208 and process payments. The system 100 makes billing quicker, easier, and less expensive for the biller or the vendor; provides an improved customer interface; and provides the biller or the vendor with more control over billing document printing and payment processing.

In the embodiment depicted in FIGS. 1-3, the system 100 includes one or more computing devices 108, 110, and 112 which perform various functions and operations in accordance with the invention. Each computing device can be, for instance, a processor, personal computer (PC), server or mainframe computer. The system 100 can be implemented in a network configuration or a variety of data communication network environments using software, hardware or a combination of hardware and software. Each computing device 108, 110, or 112 may also be provided with one or more components or subsystems including, for example, a processor, co-processor, register, data processing devices and subsystems, wired or wireless communication links, input devices and monitors beyond what is shown. The databases 120, 122, and 124 depicted in the figures can be implemented by one or more memory or storage devices such as one or more databases.

All or parts of the system can be stored on or read from computer-readable media, which may have stored thereon machine executable instructions for performing the operations of the system 100. Computer readable media may include, for instance, storage devices such as floppy disks, hard disks, CD-ROM, read-only memory (ROM), random-access memory (RAM), or a carrier wave received from the Internet.

The processes of the invention can be implemented in a variety of ways and include other modules, programs, applications, scripts, processes, threads or code sections that interrelate with each other. The program modules can be commercially available software tools using custom object-oriented code written in C++ programming language, using applets written in Java programming language, or be implemented with discrete electrical components or as one or more customized hardwired application specific integrated circuits (ASIC).

FIG. 1 shows how the components of the system 100 are related internally and externally and how the user 102 interfaces with components of the system 100 as well as the billing and payment processes. In the embodiment shown, a user 102 interfaces with the system 100 via an Internet interface 104. The user 102 can be a vendor, a biller, a customer, or any individual using the system 100. The Internet interface 104 communicates with a system software processor 108 through the Internet 106. The system software processor 108 is in communication with a printing processor 110 and a remittance processor 112. The system software processor 108 is also in communication with a printing and accounts receivable database 120 and a payment database 122. The printing processor 110 communicates with, at least, printing hardware 202, packaging hardware 204, and mailing or shipping hardware 206 to send a billing document 208 to a customer. The printing hardware 202 can be a commercial printer and the like. The printing hardware 202, the packaging hardware 204, and the mailing or shipping hardware 206 also communicate with the printing and accounts receivable database 120. An image of the billing document 208 is stored in an image database 124. The image database 124 is also in communication with the Internet interface 104.

The system 100 also communicates with, for example, a lockbox 302 and a payment processor 304 to process deposits 306 with a financial institution 308. The payment processor 304 can include remittance processing machinery. The lockbox 302, the payment processor 304, and deposits 306 are in communication with the payment database 122. The payment processor 304 is also in communication with the image database 124 so that an image of the payment or deposit 306 can be stored. Thus, the user 102 can retrieve an image of a billing document 208, a payment, or a deposit.

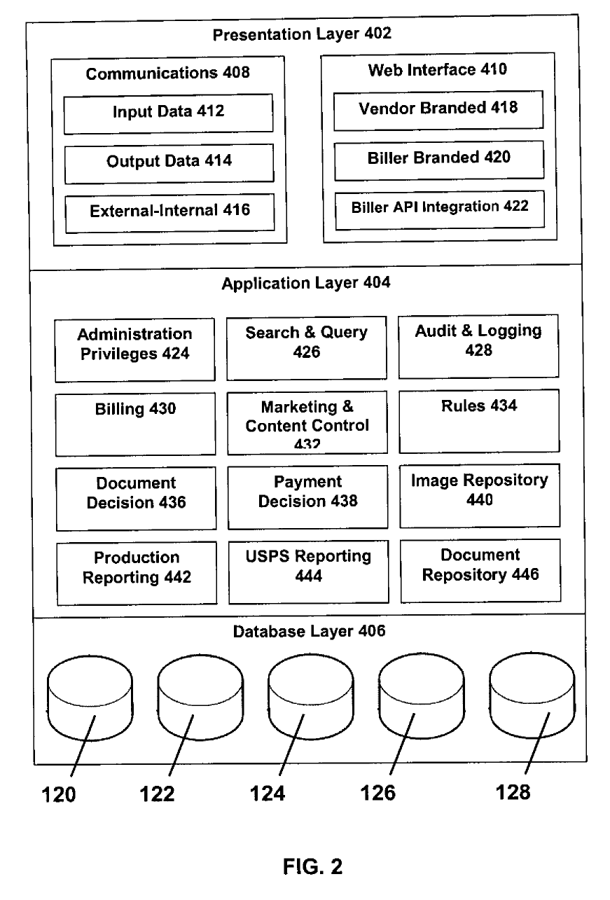

Machine executable instructions coordinate and control the operation of the system 100 and interactions with various hardware components (such as printing hardware 202, the packaging hardware 204, the mailing or shipping hardware 206, the lockbox 302, and the payment processor 304). The machine executable instructions can be stored either in the system software processor 108 or in the system software processor 108 and several other computing platforms. Referring to FIG. 2, an exemplary architecture for machine executable instructions for coordinating and controlling the system 100 is schematically shown. In the embodiment shown, the machine executable instructions have three layers: the presentation layer 402, the application layer 404, and the database layer 406. The layers 402-406 are schematic representations of how various components of the machine executable instructions interact with one another. The machine executable instructions interact with and control one or more databases 120-128 at the database layer 406 that interface internally with a series of application components 424-446 at the application layer 404 and interface externally via the presentation layer 402 with production application software that control the printing hardware 202, the packaging hardware 204, the mailing or shipping hardware 206, the lockbox 302, the payment processor 304, or other parts of the system 100.

In accordance with the schematic, machine executable instructions components (such as application components 424-446, databases 120-128, interfacing components 408, 410 and other components) are also grouped into separate layers 402-406 within the machine executable instructions code to work in conjunction with one another and to provide the system 100 with greater flexibility and customizability. The components exist within the layer 402, 404, or 406, and the transfer of data and instructions occurs between the layers 402-406 rather than having the individual components communicate directly with other components. By utilizing these separate layers 402-406, any of the components within a layer can be modified without having to modify each individual connection between that component and other components of the machine executable instructions because the connections between components occur through the layers 402-406. Thus, the machine executable instructions are more flexible and customizable when compared to machine executable instructions that do not use application layers 402-406, where any change to a component of the machine executable instructions require altering how the component operates, connects, communicates or otherwise interacts with other components.

The other advantage of using layers 402-406 in the architecture of the machine executable instructions is that the layers 402-406 add security to the system 100. For example, users 102 (i.e., the vendor, the biller, the customer, or some other individual interfacing with the machine executable instructions) of the system 100 interface with the machine executable instructions via the presentation layer 402, typically through the web interface 410. But because the web interface 410 is contained within the presentation layer 402, communications between the presentation layer 402 and the databases 120-128 in the database layer 406 have to go through the communications protocols used between layers 402-406. Also, only data and instructions that are property presented are communicated by the machine executable instructions from the presentation layer 402 to the application layer 404 and to the database layer 406. Thus, the communication protocols between layers 402-406 that only communicate properly presented data and instructions prevent users 102 from knowingly or unknowingly gaining direct access to the databases 120-128 and corrupting the data, as only proper instructions are passed between the layers 402-406.

The presentation layer 402 provides an interface with the machine executable instructions for other software systems or for users 102 of the system 100. The presentation layer 402 includes, at least, a communications module 408 and a web interface 410. The communications module 408 and the web interface 410 are part of or presented through the Internet interface 104. The communications module 408 allows communication between the system 100 and outside systems, and the web interface module 410 allows users 102 to interact with the system 100.

The communications module 408 contains components that communicate with external or outside systems, such as the biller's systems. For example, if an authorized biller's customer relationship management software is programmed to extract data from the billing document printing and payment processing, it would communicate the request through the communications module 408. In the embodiment shown in FIG. 2, the communications module 408 includes an input data component 412, an output data component 414, and an external-internal component 416. The input data component 412 handles and processes data that is sent to the machine executable instructions and routes the data to the appropriate part of the machine executable instructions for further processing by other components. For example, a biller can send raw data from its billing system into the machine executable instructions on a cyclical basis. The system 100, based on preset rules, processes the request and transfers data to the printing and accounts receivable database 120 for processing. The output data component 414 operates similarly to the input data component 412 except that the output data component 414 handles and processes data that is being transferred from the machine executable instructions to outside systems. The external-internal component 416 determines which data and which requests are allowed into the application layer 404 and which data and which requests are allowed to leave the application layer 404. The external-internal component 416 processes all data and requests moving through the communications module 408 and works together with the input data component 412 and output data component 414 to direct data flow.

The web interface module 410 allows users 102 to interact with the system 100, and in the embodiment shown, the users 102 interact with the system 100 via a Web-based graphical user interface (GUI). The web interface module 410 handles all requests and instructions made by a user 102 directly into the machine executable instructions and prepares the data and requests for transfer to the application layer 404. In the embodiment of FIG. 2, the web interface module 410 includes a vendor branded component 418, a biller branded component 420, and a biller application programming interface (API) integration component 422. The vendor branded component 418 provides a vendor with access to the system 100. The vendor branded component 418 can be visually branded in the GUI with the vendor's colors, logo, etc. The biller branded component 420 provides a biller with access to the system 100. The biller branded component 420 can also have the biller's colors, logo, corporate branding, etc. Thus, each vendor and biller can have a unique branded component 418 or 420 in the web interface module 410. The biller API integration component 422 enables the system 100 to communicate with outside systems via Web services and enables instructions made by outside systems via Web services to be executed within the system 100. In some embodiments, the web interface module 410 can work with one or more of the components 424-446 in the application layer 404 to provide the vendor branded component 418 or the biller branded component 420.

The presentation layer 402 is in communication with the application layer 404. The application layer 404 carries out the requests by users 102, seeks required data from the database layer 406, and communicates the results to the presentation layer 402 for the user 102. When a user 102 wants to perform an action, that request is sent to the application layer 404. The application layer 404 controls all of the functions of the machine executable instructions through components 424-446 within the application layer 404. Each component 424-446 within the application layer 404 is responsible for a different operation. For example, a user 102 may want to search for a particular payment that was made by a customer. The user 102 makes the search request from the web interface module 410 within the presentation layer 402. The request is processed by the application layer 404 which searches database indexes to determine which database 120-128 contains the requested data and sends a request to the database layer 406 to retrieve the requested data. The application layer 404 then receives the requested data and composes the data into the format required by the presentation layer 402 to be presented to the user 102.

In the embodiment depicted in FIG. 2, there are twelve components or modules 424-446 within the application layer 404: an administration privileges module 424, a search and query module 426, an audit and logging module 428, a billing module 430, a marketing and content control module 432, a rules module 434, a document decision module 436, a payment decision module 438, an image repository module 440, a production reporting module 442, a USPS reporting module 444, and a document repository module 446. Each module 424-446 performs a specific function within billing and payment processing. The modules 424-446 work together with each other and with the components 408-410 in the presentation layer 402 and the databases 120-128 of the database layer 406 to complete billing and payment processing.

The administration privileges module 424 controls security and access to the system 100. The module 424 checks user 102 permissions and allows users 102 access only to the sections for which they are authorized. The module 424 also allows users 102 with administrative rights to make changes to the system 100, within a limited range of options, such as adding new users 102 and assigning new user privileges.

The search and query module 426 allows users 102 to search for data within the databases 120-128. The module 426 processes requests for data, retrieves the appropriate data, and communicates the data to the presentation layer 402.

The audit and logging module 428 records interactions with the system 100 from outside systems and users 102. The audit and logging module 428 records activity from all layers 402-406. The recorded activity can be stored in the audit and logging database 128 in the database layer 406. The module 428 also serves as a control point and detects unusual behavior between various points within the layers 402-406. The module 428 creates alerts and performs shut down functions if the system 100 is deemed in danger. In the embodiment shown, the data from the audit and logging module 428 is stored in an audit and logging database 128 within the database layer 406. The module 428 also presents recorded interactions when requested by users 102. The module 428 constructs data and statistics into readable formats that are communicated to the presentation layer 402.

The billing module 430 handles functions related to generating billing documents 208 for customers. The functions can include advanced billing functions such as optimizing weight to minimize postage costs.

The marketing and content control module 432 enables users 102 to customize the content of billing documents 208. The module 432 applies content rules as defined by the users 102 to the billing document print production process.

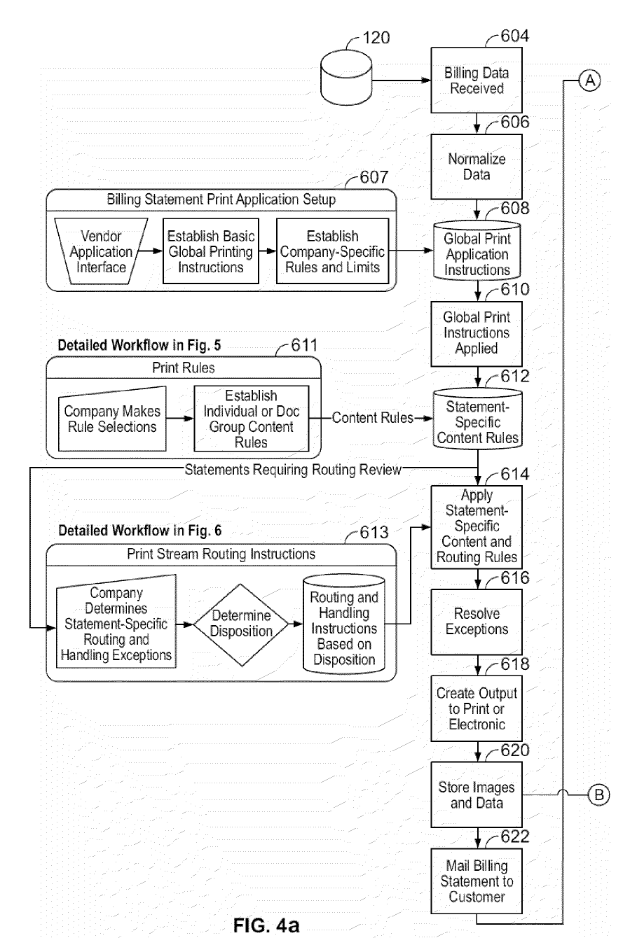

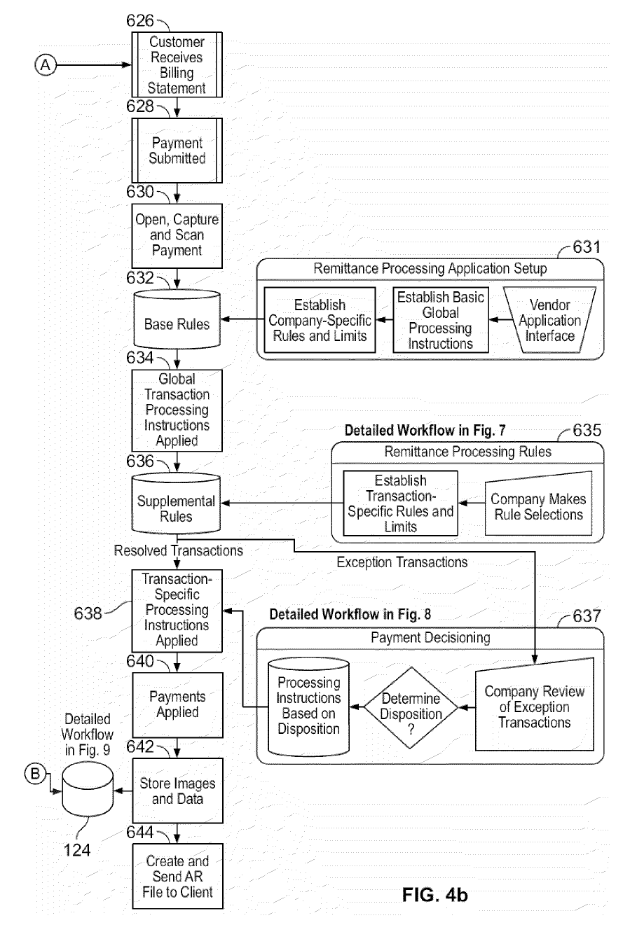

The rules module 434 forms and applies rules, such as print rules, content rules, and routing rules. The rules module 434 allows users 102 to input instructions to form print rules. The rules module 434 then applies the print rules at the appropriate time during the billing document print production process. The rules module 434 can include a billing statement print application setup module 607 (shown in FIG. 4a) to form print rules, a print rules module 611 (shown in FIG. 4a) to form content rules, and a print stream routing instructions module 613 (shown in FIG. 4a) to form content and routing rules.

The document decision module 436 executes decisions made by the user 102 as to the disposition of certain documents. Under certain circumstances, the machine executable instructions ask the user 102 how certain documents should be handled. For example, if the print rules cannot be applied in the billing document print production process, the machine executable instructions ask for more instructions. The module 436 requests further instructions from the user 102 and then executes those instructions in the document production workflow which is also handled by this module 436.

The payment decision module 438 presents and executes decisions made in regards to payments. Under certain circumstances, such as when the remittance rules cannot be applied to a particular payment, the machine executable instructions ask the user 102 how certain payments should be handled and deposited. The module 438 requests further instructions from the user 102 and executes those instructions in the payment processing workflow handled by this module 438. In the embodiment shown, the payment processor 304 processes payments in accordance with the payment decision module 438.

The image repository module 440 processes all requests related to capturing images, processing images, and storing images captured during the print production process and payment processing workflows. The module 440 indexes images and creates associations between the images and related data. The images can be stored in the image database 124 or the warehousing database 126 in the database layer 406.

The production reporting module 442 generates reports related to production and payment activities. The module 442 retrieves data, assembles the data, and in some cases, processes the data to generate reports. The reports allow users 102 to monitor and analyze the print and remittance production processes.

The USPS reporting module 444 generates reports related to mailing and interacts with the United States Postal Service (USPS). The module 444 retrieves data, assembles the data, and in some cases, processes the data to generate reports. The reports allow a user 102 to monitor and analyze the mailing process. The module 444 can also generate data required by the USPS in order to complete mailings or receive postal discounts. The data required by the USPS is related to the billing document print production process, such as an analysis of weights of mail pieces, number of pieces, etc. The USPS reporting module 444 communicates with the document repository module 446 so that a user 102 can track a mail piece being delivered to the customer or when a customer sends the mail piece back for payment processing.

The document repository module 446 stores related information in the form of reports that were generated from other external software components used in the processing of bills and payments.

The database layer 406 contains data used by the machine executable instructions in one or more databases 120-128. When data is required by a component of the machine executable instructions, a request is made to the database layer 406. Protocols within the database layer 406 determine which of the databases 120-128 within the layer 406 contain the data, retrieve the data from those databases 120-128, and return the requested data to the application layer 404. The databases 120-128 are physically and logically separate for several reasons, such as processing performance, security, and flexibility. The data stored in the databases 120-128 relates to the billing documents 208 and remittances. For example, the data stored can include data regarding the layout of the billing document 208, the printing of the billing document 208, the mailing of the billing document 208, messages that are to be printed on billing documents 208, images that are to be included on billing documents 208, the processing of remittances, and other similar data. There can be other databases that store information about the biller 102, the customer 102, or the vendor 102. Such databases contain data such as contact information, bank or depositing information, regulatory information, and the like.

In the embodiment of FIG. 2, the database layer 406 contains five databases 120-128 housing different types of data: a printing and accounts receivable database 120, a payment database 122, an image database 124, a warehousing database 126, and an audit and logging database 128. The printing and accounts receivable database 120 is a physically separate database to optimize processing of multiple biller applications. Portions of the image database 124 that is deemed older data or data that is retrieved on a less frequent basis are stored in the warehousing database 126 to optimize data storage and performance. In some embodiments, one or more databases can store information about the biller 102, the vendor 102, and/or the customer 102. The stored information can include, for example, account information, identifying information, contact information, and other information related to the biller 102, the vendor 102, and the customer 102.

The printing and accounts receivable database 120 stores data related to billing and printing billing documents 208. The data contained in this database 120 is used, for example, to construct the billing documents 208, print the billing documents 208, and form electronic versions of the billing documents 208. The database 120 also stores instructions for handling billing documents 208.

The payment database 122 contains data related to payments that customers send to the vendor, such as payment amounts. The database 122 also stores instructions for deposits and instructions for handling payments as they are received.

The image database 124 stores images of billing documents 208 that are printed using the system 100. The image database 124 also store images of payments received and processed by the system 100. Images can be received from the image repository module 440 in the application layer 404.

The warehousing database 126 contains normalized data from the payment database 122 in order to effectively report on data and functions over an extended period of time. Older or less frequently accessed images of the image database 124 can be stored in the warehousing database 126. The image repository module 440 in the application layer 404 can send images to the warehousing database 126.

The audit and logging database 128 stores records of when the system 100 is used by which user 102 and tracks the activities of each user 102. The database 128 also contains security data which enables only authorized users 102 to access only the parts of the system 100 for which they are authorized.

With the architecture shown in FIG. 2 for the machine executable instructions, multiple functions are available at different layers 402-406. Each function can interact with one or more layers 402-406 and the components of those layers 402-406. For example, a biller can send data into the system 100 through the presentation layer 402 using the communications module 408, and the application layer 404 moves the data to the database layer 406 where the data is stored in the printing and accounts receivable database 120. The biller can also access data or other functions through the presentation layer 402 via the Web interface module 410 using the biller branded component 420. For example, the biller can access the image repository module 440 in the application layer 404 to retrieve images or to add images. The image repository module 440 in the application layer 404 processes the image requests and accesses the image database 124 in the database layer 406.

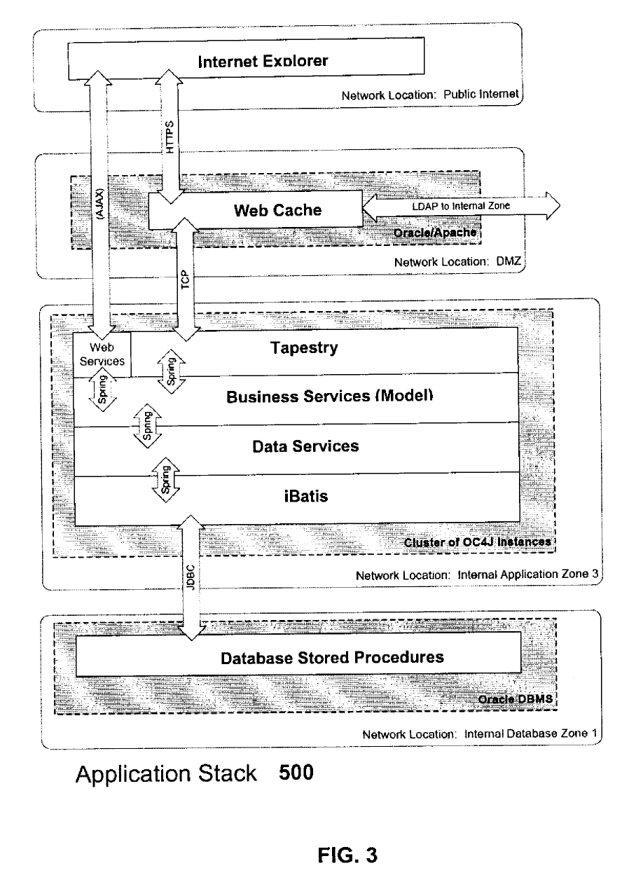

Referring to FIG. 3, an application stack 500 is shown. Each of the layers 402-406 work together to create an application stack. The application stack 500 is a collection of working components built from common software and technology components used by, for example, the vendor. The foundation of the application stack 500 is the databases. The vendor can use Oracle databases to store and link data elements. The databases are relational so that common data elements are stored within many tables and relate to each other. These relational tables interface with the application layer 404. The application layer 404 stores features and functions of the system 100 and provides a communication pathway between the presentation layer 402 and the databases. The vendor can use a variety of communications protocols for the communications pathways, such as iBatis, data services, business services, and Tapestry. The vendor can also use common WEB services and Spring, as the communication device. The presentation layer 402 is used to externalize the application and database components in a controlled manner. The vendor can use Oracle and Apache as a Web Cache that communicates with Internet Explorer and the application layer 404 via AJAX, TCP, or HTTPS.

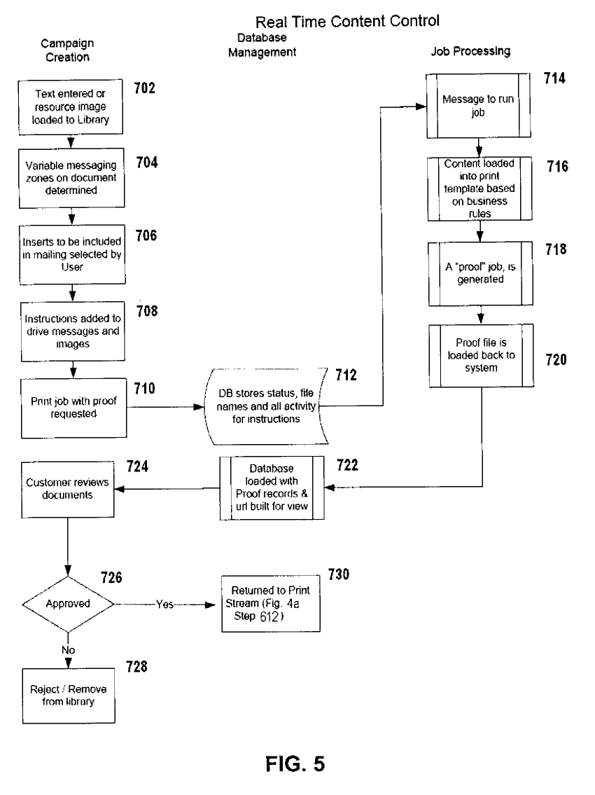

Referring to FIGS. 4a and 4b, a flowchart for printing billing documents 208 and payment processing is shown. The modules 424-446 of the application layer 404 of the machine executable instructions execute steps shown in the flowchart to print a billing document 208 and process payments. In the embodiment depicted in FIGS. 4-9, the printing of billing documents 208 is referred to as the Document Printing System (DPS), and the processing of payments is referred to as the Remittance Payment System (RPS). The vertical workflow in FIG. 4a, steps 602-622, describes the DPS operation of the system 100, and the vertical workflow in FIG. 4b, steps 628-644, describes the RPS operation of the system 100. As shown, the billing document 208 print processing includes the print rules module 611, which establishes print rules, and a print stream routing instructions module 613, which generates print stream routing instructions. The print rules module 611 can be a part of the rules module 434 (shown in FIG. 2). The remittance payment processing includes a remittance processing application setup module 631, a remittance processing rules module 635, step 634, and a payment decisioning module 637, step 638. In the embodiment shown, the remittance processing application setup module 631, the remittance processing rules module 635, and the payment decisioning module 637 can be a part of the payment decision module 438 (shown in FIG. 2). The operation of the print rules module 611, step 612; the print stream routing instructions module 613, step 614; the remittance processing rule module 635, step 636; and the payment decisioning module 637, step 638, are more fully discussed with respect to FIGS. 5-9, respectively.

In explaining the depicted embodiment, there is a biller 102 and a vendor 102. The biller 102 provides billing data to the system 100, and the vendor 102 uses the system 100 to prepare the billing documents for the biller 102. The process of printing the billing document 208 begins with the system 100 receiving billing data from the biller 102, step 604. The billing data is generally the data sent by the biller 102 to the vendor 102 from which billing documents 208 are composed and printed. The billing data can be a file or files from the biller 102 and contains data relevant for billing purposes, such as customer name and address, billing address, billing amounts, amount due, account numbers, etc. The billing data varies from biller 102 to biller 102. In the embodiment shown, the billing data is transferred from the biller 102 to the vendor 102 through the communications module 408 of the presentation layer 402 and stored in the printing and accounts receivable database 120 of the database layer 406. As part of pre-processing, the data is “normalized” or converted from the format used by the biller's outside system to a format used by the system 100, step 606. The normalized data is stored in the warehousing database 126.

Before billing documents 208 are printed for a biller 102, a software application for printing must be set up through a billing statement print application setup module 607. In the embodiment shown, the billing statement print application setup module 607 is a separate module from the rules module 434. The instructions established during the billing statement print application setup module 607 determine exactly how the received and normalized billing data is processed, composed, assembled, and distributed, step 608. The vendor 102 uses the billing statement print application setup module 607 to establish print rules that are standard to all print applications as well as rules that are specific to a particular biller 102, thus setting up the system 100 for use by a particular biller 102. In the embodiment shown, the vendor 102 accesses the billing statement print application setup module 607 through the vendor branded component 418 of the web interface module 410. Once the vendor 102 sets up the system for a particular biller 102, the biller 102 then accesses the print rules module 611 to specify rules for a group of billing documents 208 for the biller's customers. In the embodiment shown, the biller 102 uses the biller branded component 420 to interface with the rules module 434 which can include a print rules module 611.

Biller-specific processing instructions for printing or global print application instructions 608 are applied, step 610, to the received and normalized billing file from steps 604 and 606. The global print application instructions are also referred to as print rules, and these print rules are referred to as “global” because these rules are applied to all records that are processed for printing for a particular biller 102. The “global” designation applies to the billing documents 208 of a particular biller 102, as each biller 102 has a separate application and a separate set of “global” rules. At step 610, rules can be applied to the data to optimize postal processing, conduct address corrections, apply inserts, calculate mailing weights, and create an index for printing, electronic delivery, and web interface archiving.

The system 100 also provides the ability to customize the production, content, and delivery of smaller groups of billing documents 208 or individual billing documents 208. In the embodiment shown, the billing module 430 together with the rules module 434 customizes the production, content, and delivery of one or more billing documents 208. The biller 102 uses the print rules module 611 to establish individual or document group content rules, step 612. In the embodiment shown, biller 102 uses the biller branded component 420 of the web interface module 410 to interface with the print rules module 611, and the print rules module 611 applies content rules that apply to one billing document 208 or a particular group of billing documents 208, step 612. The print rules module 611 is described more fully with respect to FIG. 5. The content rules detail changes to the bill content for specific billing documents 208 and are applied, as shown in step 614, before printing and insertion occurs. Also, as shown in FIG. 2, the rules module 434 and the marketing and content control module 432 can work in conjunction with the printing and accounts receivable database 120 to change the content and delivery of billing documents 208.

Beyond document-specific instructions for different content or marketing messages on the billing document 208 itself statement-specific routing and handling instructions can control how the billing document 208 is to be processed. The biller 102 can provide print stream routing instructions or rules that enable the biller 102 to govern how specific documents 208 or groups of documents 208 are routed and handled prior to printing or mailing, through the print stream routing instructions module 613. In the embodiment shown, the biller 102 uses the biller branded component 420 of the web interface module 410 to access the print stream routing instructions module 613 to form statement-specific routing and handling exceptions. These statement-specific routing and handling exceptions form routing and handling instructions after determining disposition. The print stream routing instruction module 613 allows different inserts to be mailed with the billing document 208 within the envelope, an alternate delivery address, alternate delivery method, a request to electronically send an image of the billing document 208 to the biller 102 prior to mailing, or a different method for delivery such as electronic or alternate media such as CD/DVD. The rules created using the print stream routing instructions module 613 are created by the biller 102 are entered directly into the bill printing workflow. After the global print instructions or global print rules are applied to the billing data, statement-specific content rules from print rules module 611 and routing and handling rules from the print stream routing instructions module 613 are applied, step 614. In the embodiment shown, the global print rules and statement-specific content rules for one or more billing documents 208 are retrieved based on, for instance, the account or customer code associated with each user 102.

As an example of an application of global print rules and content rules, the global print rules may state that any billing document 208 with a balance due under $5.00 be suppressed and not printed or mailed to the customer. That global print rule is applied to every batch of billing documents 208 printed for a particular biller 102 and is unlikely to change very often. A print rule that applies to a smaller group of billing documents 208 usually changes more often. For example, a biller 102 can create a customized message that only appears on certain billing documents 208 with a balance due amount over $250.

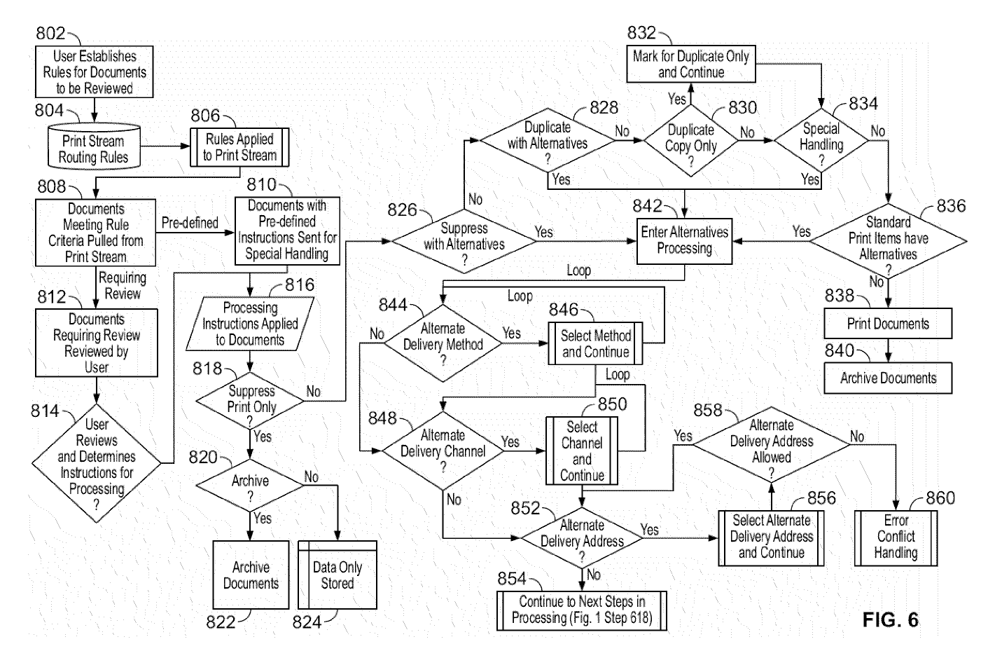

At step 616, if there are any exceptions to either the global rules or statement-specific rules governing the printing or processing of billing document 208, or if there is a specific rule that designates certain billing documents 208 to be pulled for manual review, in the depicted embodiment, the document decision module 436 presents exceptions via the web interface module 410 to the biller 102 to resolve those exceptions. The print stream routing instructions can provide an opportunity for the biller 102 to review an electronic version of the billing document 208 before it is printed or mailed, as discussed more fully with respect to FIG. 6. The biller 102 can provide print stream routing instructions or rules so that a billing document 208 is not mailed immediately and is held for the review and disposition by the biller 102. The biller 102 uses the biller branded component 420 of the web interface module 410 to select how to resolve each individual exception documents 208, and these exception document 208 are returned to the workflow to be printed and mailed or should be rejected and not printed or mailed.

After completion of processing, the data files are sent to printing hardware 202, step 618. As the documents 208 are printed, an image of each document 208 is captured by the system 100, step 620. Images of the documents 208 are stored in the image database 124, step 620, for future review by the biller 102. Biller specific data is extracted from the data files sent to printing hardware and associated with each image and stored with the image in the image database 124. For example, information such as account number, invoice number, date processed, or other pertinent information is stored with the image in the image database 124. The information associated with each image is subsequently used to research and view the image.

In the embodiment shown, after the billing document 208 has been printed and image of it stored in the image database 124, the billing document 208 is sent to the packaging hardware 204 and the mailing or shipping hardware 206 to be inserted into envelopes, and mailed via the United States Postal Service, step 622. The printing, insertion, and distribution are governed by the print rules. The billing documents 208 are sent via the United States Postal Service, step 622, to the customer.

Turning to FIG. 4b, after the billing document 208 is mailed to the customer, step 622, the system 100 waits to receive a payment from the customer, step 628. After the customer receives the billing document 208 and sends payment, the payment is received in the lockbox 302. The payment is typically sent to a post office box, commonly called a lockbox 302, controlled by the vendor 102 for payment processing. The vendor 102 retrieves all payment envelopes sent to that biller's lockbox 302 multiple times daily for processing. When remitted to the biller 102, the payment envelope typically includes a check for payment and a coupon, which was detached from the original billing document 208 and contains relevant account and payment information. After being transferred from the lockbox 302 to the vendor's processing facility, the vendor 102 opens each payment envelope, scans a computer-coded line on the returned payment coupon containing individually-identifiable account and billing information, and captures an image of every document using camera-equipped scanning machines, step 630. The computer-coded line on the returned payment coupon that contains individually-identifiable account and billing information is also known as a scan line or microline. In the embodiment shown, the system 100 uses the information from the scan line to retrieve information related to that remittance, such as the biller 102, the corresponding billing document 208, the applicable remittance rules, and other similar information. If the system 100 cannot read the scan line, the system 100 retrieves related information based on an optical scan of the account number, and if the optical scan of the account number is unreadable, the system 100 retrieves related information based on a scan of the name and address on the returned payment coupon. If the scan line, the account number, the name, and the address are unreadable, the system 100 submits the remittance for manual review. In other embodiments, remittance rules can establish a different hierarchy of information to be used for retrieving information related to the remittance.

Before the payments can be processed for a biller 102, a software application for remittance processing is set up. In the embodiment shown, the setup is accomplished by a remittance processing application setup module 631, which is accessed via the web interface 410. The remittance processing application setup module 631 enables a vendor 102 or a vendor representative to customize the setup through a Web-based interface without custom software coding. In the depicted embodiment, the vendor 102 or the vendor representative interfaces with the remittance processing application setup module 631 through the vendor branded component 418 of the web interface module 410. The biller 102 uses the remittance processing application setup module 631 to establish basic global processing instructions and biller-specific rules and limits. The biller 102 can use the remittance processing application setup module 631 to establish, for example, account number schemes, amounts, processing schedules, remittance coupon layouts, and other aspects related to remittance processing. The remittance processing instructions established during the remittance processing application setup module 611 determine how the payments are processed, applied, and deposited. In the embodiment shown, the biller 102 interfaces with the remittance processing application setup module 631 through the biller branded component 420 of the web interface module 410.

The base rules are formed from output of the remittance processing application setup module 631, step 632. In the embodiment shown, the rules are stored in the payment database 122. The rules stored in the database are associated with a specific application that is processed on a predetermined processing schedule. The rules initially established can later be modified based on the needs of the biller 102.

The global transaction processing instructions or global remittance rules for handling payments are applied, step 634. The global transaction processing instructions or global remittance rules may include, for instance, specific instructions regarding disposition of payments, what types of payments to accept or reject, and how to handle exceptions. In the embodiment shown, the system 100 uses the scanned data from step 630 to access the correct global transaction processing instructions to be applied to the payment. The system 100 also uses the scanned, relevant account and billing information to match the incoming payments and USPS tracking information with the original outgoing billing documents 208 as part of applying the global transaction processing instructions. Furthermore, information from the billing data, such as the amount or mailing address, is used to apply the payment to the correct account during remittance processing.

The system 100 provides the ability to customize the processing, application, and depositing of smaller groups of payments or individual payments. In the embodiment shown, the biller 102 provides supplemental rules through the remittance processing rules module 635. The remittance processing rules module 635 is accessed via the biller branded component 420 of the web interface 410. The supplemental rules are formed from the transaction-specific rules and limits established by the biller 102. These supplemental rules or payment-specific instructions may dictate different methods of processing payments, instructions for handling individual payments that differ from the global instructions, rules for applying payments, handling individual exception scenarios, etc.

After the global remittance rules or global transaction processing instructions are applied to the payment, the system 100 accesses the supplemental rules that apply to smaller groups of bills, step 636. In the embodiment shown, the system 100 accesses the correct set of supplemental rules based on the account information. As an example of global transaction processing instructions and supplement rules, a global transaction processing instruction can state that all payments over $5,000.00 are sent to the web interface 410 for review, or the global transaction processing instruction can state any payment within $1.00 of amount due shall be processed. A supplemental rule applies to a specific account. The supplemental rule can be that a payment associated with a certain predetermined account number is routed online to review.

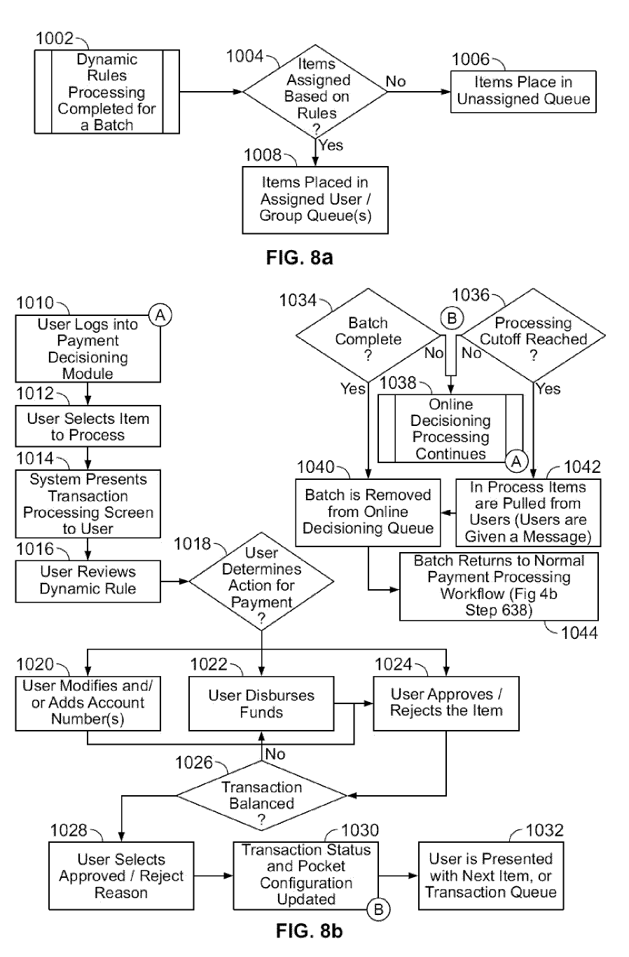

The transaction-specific processing instructions that detail specific instructions for handling individual payments are applied, step 638. During this process, there may be exceptions to either the global transaction processing instructions or the supplemental rules that require the biller 102 to manually review and make a decision on how that payment should be handled and applied. The payment decisioning module 637 processes the exceptions. The exceptions are presented via the biller branded component 420 of the web interface module 410 to the biller 102 to make a decision on how each payment should be processed. The biller 102 uses the biller branded component 420 of the web interface module 410 to select how to handle each individual exception, and these exception payments are returned to the workflow to be processed and applied or rejected and handled based on the biller's instructions, which will be discussed in more detail with regard to FIGS. 8a and 8b. In the embodiment shown, the web interface 410 presents remittance information about the exception and an image of the exception. After reviewing the exception, the biller 102 may update an account number, disburse funds to different categories such as principal and interest, approve the item for continued processing and deposit, select “No Pay” to prevent depositing the remittance and to send it back to the customer, or other similar actions related to remittance processing.

At this point in the workflow, each payment has a specific instruction on how that payment should be applied and deposited or rejected, as established in steps 632, 636, and 638, and it is deposited or rejected appropriately, step 640. Once handled successfully according to the remittance rules or instructions, the captured images of the payment, coupon, and any other documents included in the payment envelope, as well as the data relating to how the payment was applied (or rejected) and deposited, is sent to the image database 124 (shown in FIG. 1) to be stored, step 642.

The system 100 then generates an accounts receivable file (AR file) which is transmitted to the biller's accounts receivable department, step 644. The system 100 transmits the AR file to the biller's accounts receivable system to update customers' accounts with payments processed. The file is formatted based on instructions provided by the biller 102 and entered into the system 100 in step 632, using the remittance processing application setup module 631. The system 100 can deliver the AR file electronically, by paper, or both; thus, the system 100 can provide the AR file in a single data stream so that electronic billing documents 208 can be easily matched with their paper counterparts. The system 100 can also provide the billing documents 208 divided according to their delivery media, i.e., paper, electronic, or both.

Referring to FIG. 5, a flowchart for the workflow of the print rules module 611 (shown in FIG. 4a) of the rules module 434 (shown in FIG. 2) which contains the statement specific content rules is shown. The print rules module 611 applies the statement-specific content rules to the billing documents 208, step 612 (shown in FIG. 4a). The print rules module 611 has various sub-modules or functions, including a library function (step 702), document function (step 704), insert function (step 706), campaign function (step 708), and proofing function (step 710). These functions 702-710 allow a biller 102 to enter and upload content and images to a content library via the library function (step 702) and then have that content printed in specified areas of the billing documents 208 via the document function (step 704) during the print process based on statement-specific content rules as defined by the biller 102. Billers 102 may have limited access to some sections of the module 434 based on the permission set by an administrator. An “administrator” can be a representative within the biller's company tasked with managing access to the software. The administrator can grant and deny access to certain parts of the software or processes.

Starting with step 702, billers 102 can add text or images to the system 100 using the web interface module 410 through a library function that is a part of the rules module 434. An image is uploaded through the web interface 410 and Internet interface 104. A rule or a series of rules based on the biller's data is associated with the uploaded image. The image is applied to a billing document 208 by a rule that invokes and applies the image. The text and images that are added to the library are stored in the image database 124 (shown in FIG. 2) or the printing and accounts receivable database 120 (shown in FIG. 2). If an image is being added, the image is stored in the image database 124, and if text is being added, the text is stored in the printing and accounts receivable database 120.

Turning to step 704, the administrators can also define which sections of the billing document 208 templates are available for editing by the biller 102 by using the document function. A billing document 208 is divided into several zones, and each zone can be associated with a list of instructions. Once the billing document 208 zones are defined, the biller 102 can insert text or images to populate those zones. For example, on a printed billing document 208, the top quarter of the document 208 may be designated as a zone for marketing messages. Alternatively, the biller 102 can designate that all bills with a balance due of under $200 contain one message in that pre-defined zone, and all bills with balances of $200 or over contain a different message in that same pre-defined zone.

In step 706, the inserts function allows a biller 102 to configure which documents are included in the billing envelope along with the billing document 208 based on a set of instructions. The system 100 displays a list of insert conditions in priority order via the communications module 408 or the web interface module 410. The list can be re-sequenced by dragging and dropping an item into place. The list allows individual inserts to be deleted from the list of inserts to be inserted into a particular billing envelope. A delete action must be confirmed. However, some inserts are designated as “required” during setup in either step 632 or step 636. If the insert is marked by the biller 102 or vendor 102 as “mandatory,” it will always be included. An example of a mandatory insert is the return envelope for the payment. The designations are used during processing to determine whether the insert can be skipped if it would make the envelope overweight or otherwise break some other rule.

The biller can create a “campaign” using a campaign function, step 708. The combination of a message with a designated rule or rules that define on which billing documents 208 the message is printed is referred to as a “campaign.” Users 102 can specify different contents for their billing documents 208 and different inserts in their mailing envelope based on the instructions created with the campaign function. The campaign function is typically used for promotional messages. The campaign function can also be used to sell products to one or more customers, to solicit additional funds for a cause, and other similar actions where information is sent to many customers. The campaign function is a set of instructions dictating the text and images that are printed on a billing document 208 or group of billing documents 208 based on a set of filtering criteria. These instructions can also control which marketing materials are inserted into the billing envelope along with the billing document 208. Once created, campaigns are then stored by the system 100 as part of the supplemental rules. The list of campaigns can be filtered to include any combination of past, present, and future dated campaigns. Once the text or image has been added to the library, the biller 102 can add the text or image items to individual billing documents 208 or sets of billing documents 208 through the campaign function. A “set” of billing documents 208 can be any number of billing documents 208 that are grouped based on a common element. For example, a set can include billing documents 208 being sent to customers in Ohio or billing documents 208 with balance dues of less than $100.

Billers 102 can review images of the billing documents 208 using the proofing function via the communications module 408 or the web interface module 410 before printing, step 710. The images allow the biller 102 to ensure that the composition of the billing document 208 is correct. The proofing function allows the biller 102 to view proofs that have already been completed or request a new proofing job to start. When a proof is requested, the image database 124 stores the details of the campaign, step 712, and sends the instructions to the printing and accounts receivable database 120, step 714. The content, as uploaded by the biller 102, is added to the print template based on the instructions for the campaign, step 716. A print job specifically for proofing purposes is created in the system, step 718. A separate print job proofing is generally created because the proof is a sample billing document 208 used for reviewing purposes and not a real billing documents 208 to be sent to a customer. Images of the proofs, generally in pdf format, are generated, step 720, and sent to the image database 124. Also, the system 100 can provide a specific URL from which the biller 102 can view the proof via the web interface module 410, step 722.

The biller 102 reviews the proofs, step 724, and decides if the proofs are ready for production, step 726. If the proofs are rejected, the campaign and associated rules are removed from the library, step 728. If the proofs are accepted, the campaign and associated rules are inserted into the print workflow, step 730, at step 612 of FIG. 4a. Because an electronic proof is generated, the system 100 can also allow a user 102 to forego printing and send the billing document 208 only electronically instead. Thus, the system 100 can minimize use of paper and save the users 102 the costs associated with printing billing documents 208.

Referring to FIG. 6, a flowchart describing the workflow of the print stream routing instructions module 613 is shown. The print stream routing instructions module 613 is the source for the content and routing rules, step 614 of FIG. 4a and can be a part of the rules module 434, shown in FIG. 2. The module 613 allows a biller 102 to select a certain document 208 to pull from the normal print workflow and review the document 208 in a common image format, such as pdf. The document can be viewed online via the web interface 410. The biller 102 can then determine via a status setting and reason code whether the document 208 should be suppressed, duplicated, or sent with alternative processing instructions, such as an alternate delivery method, channel or address. Users 102 of the module 613 may have limited access to some sections of the module 613 based on the permissions set by an administrator.

Documents 208 to be reviewed are presented to the biller 102 based on rules and instructions set up by the biller 102. The biller 102 sets up these rules using a print stream routing instructions module interface on the web interface module 410, step 802. The instructions are then applied to specific print jobs, step 804. Any documents 208 meeting the criteria defined in the instructions are pulled from the print workflow, step 808, and either processed using the pre-defined alternate processing method, step 810, or sent to a special handling queue for the biller 102 to review and determine how the document 208 should be processed, step 812.

Depending on the instructions or filters established for each application, the system 100 places specific items in a special handling queue, step 812. An image of the item, typically in a pdf file, is generated in the processing cycle. A notification is sent via email to individual users 102 or group users, if applicable, to alert the users 102 to items requiring special handing dispositions. To view these items, the biller 102 logs into the print stream routing instructions module 613. The biller then clicks on the record of each document 208 individually to review the associated document image, typically a pdf file. Billers 102 can then change the status and associated reason codes of the individual document 208 or group of documents 208 and save the record.

Approved items continue to the next appropriate work flow step to move forward, for example, processing of data, print output, mail distribution, etc. For rejected items, all processing and billing information are captured, but no final distribution occurs. Items or documents with a “Hold” status in their reason codes and optional comments remain in the special handling queue until approved, rejected, archived, or until a default time changes the status. After the status of a document 208 has been changed except for “Hold” items, a record of the document 208 with the new status, the date and time the status was changed, and the identity of who changed the status, moves to a history status for a 90 day period.

Once every document 208 has a disposition, the rules are applied to the documents via the print stream routing instructions workflow, step 816. Documents 208 that are to be suppressed from printing, step 818, are either sent to the image database 124 to store the image 22, step 820, or the associated data is retained, step 824.

Some documents 208 are required to be duplicated, step 830, in which case the document 208 is marked for duplication, step 832. If special handling beyond duplication (step 832) is also required, step 834, alternate processing instructions are applied, step 842. If alternate processing is not required, the document 208 is returned to the print stream, step 838.

For documents 208 that require alternate processing, step 842, an alternate delivery method, step 844, can be selected by the biller 102, step 846. For documents 208 that require an alternate delivery channel, step 848, the biller 102 selects the desired channel, step 850, from the options contained in the print stream routing instructions module 613. For documents that require an alternate address to which the document is delivered, step 852, the biller enters the address using the module interface, step 856.

Once the documents 208 have been removed from the print stream or reviewed and routing and handling rules have been applied, the documents 208 are returned to the print stream for printing, inserting, and mailing, step 854. If any of the applied instructions conflict with the standard print rules in the application or have delivery addresses that are not allowed, the documents 208 are sent to error handling for further review, step 860.

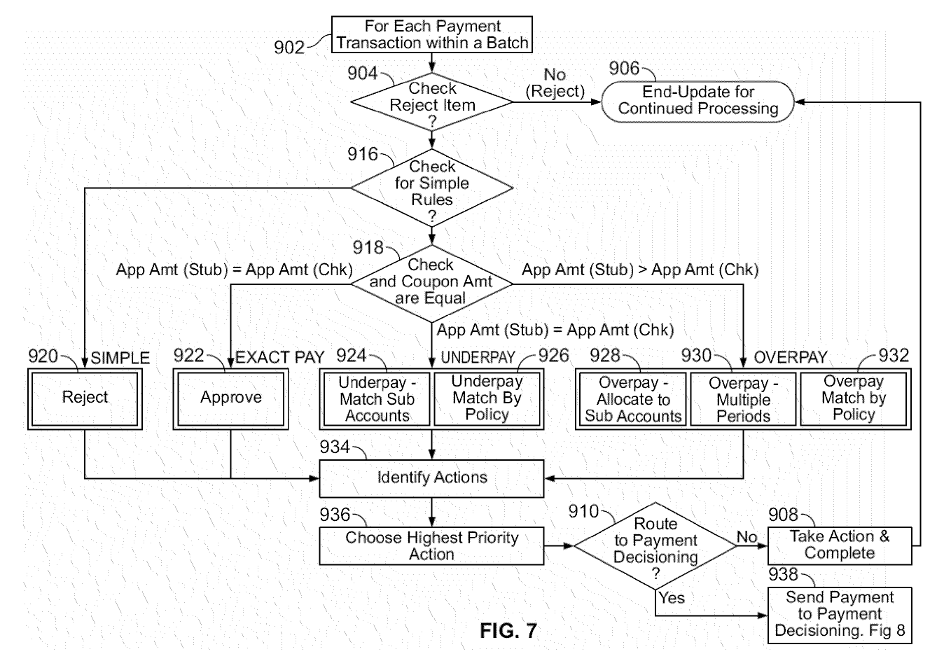

Referring to FIG. 7, a flowchart shows how remittance rules are applied. In the embodiment described, the payment processor 304 (shown in FIG. 1) applies remittance rules through the payment decision module 438 (shown in FIG. 2). Payments to be processed are grouped into batches as they move through the remittance payment processing workflow shown in FIG. 4b. In the embodiment shown, the batches generally include about 300 payments. Payments are normally collected from the USPS via a specific post office box assigned to the biller 102 throughout the day. Payments as collected are run through high speed processing equipment 304 that opens the envelope, extracts the check and coupon from the envelope, reads the coupon and check amount, and sends data to a database. Items are split into batches of approximately 300 for quality assurance purposes. As each batch is processed, the payment processing equipment 304 captures data from the bills. The data can be captured by reading the MICR line, optical character recognition, or some other method. The data obtained from each batch typically includes the information necessary to identify the correct payee, amount due, amount paid, and associated account for deposit and settlement purposes for each transaction in the batch. Each transaction in the batch is checked against a customer file which is stored in the Master Table Repository, which, in the embodiment shown, is the same as the printing and accounts receivable database 120, step 602, FIG. 4, to identify the account to which the payment should be applied. Once the correct account is found, the amount of the payment is checked against the amount due. If the amount paid matches the amount due and no other rules prevent the payment from being applied, then payment is applied. However, if the amount of payment differs from the amount due or a pre-determined rule dictates that the individual payment requires a different action or further review, then a rule supplied by the biller 102 determines how that payment should be handled on a transaction-by-transaction basis. The rule can apply underpayment, hold payment, apply overpayment to multiple accounts, etc. FIG. 7 shows the operation of the payment decision module 438, which applies remittance rules for use at step 632 of the operation of FIG. 4b.

The invention eliminates any need for customized programming by allowing an authorized biller 102 to use a Web-based software interface 410 to set these remittance rules with no manual software coding required. Once entered, these rules are established within the common processing platform and are applied directly to the remittance payment processing workflow, steps 632-640 in FIG. 4b, without requiring the intervention of software programmers.

The system 100 allows the customer to enter an instruction for each rule using an intuitive GUI interface 410, with no programming required. An instruction is a statement of what to do with an individual transaction that meets certain criteria. Rules are constructed from the parameters set by the instructions. For example, an instruction might be: “All payment amounts greater than $10,000.00 will be routed to payment decisioning and assigned to the high dollar team for resolution.” Every instruction influences workflow by determining an action during the payment processing, such as approving or rejecting a payment. The system 100 also allows for rules that send transactions in question to a queue for the biller 102 to review and decide how to handle a specific transaction. Furthermore, the interface 410 allows the biller 102 setting the rules to determine which authorized individuals receive which types of transactions for review if a rule is triggered.

Each batch is checked to see if any payments within the batch, step 902, are rejected from being applied due to triggering one of the pre-defined remittance rules, step 904. If there are no rejected items in the batch, the batch is allowed to continue to step 640 of FIG. 4, as shown in step 906. However, if a rejected transaction is detected, then the remittance rules are applied, step 916.

The remittance rules used to determine how a rejected payment should be handled can vary from biller to biller. However, the allowed types of rules are based on the payment amount compared to the amount due. The types of rules include “Exact Payment” when the payment amount matches the amount due, “Overpay” when the payment amount is more than the amount due, and “Underpay” when the payment amount is less than the amount due. Within each of the rule types there are multiple ways in which the payments can be handled. For example, some specific transactions that are overpaid can be applied to multiple accounts. First, rejected transactions are checked to see if a “Simple” reject rule is triggered, step 916. If the “Simple” rule is not triggered, then the transaction specifications are checked against the remaining rule types to see how the transaction should be handled, step 918.

Altogether, there are, at least, seven different rule types from which the biller can select: Simple (step 920), Exact Pay (step 922), Underpay—Match Sub-Amounts (step 924), Underpay—Allocate by Biller Policy (step 926), Overpay—Allocate to Sub-Accounts (step 928), Overpay—Multiple Periods (step 930), and Overpay—Allocate by Policy (step 932). “Simple” rule types are basic reject rules for exception items. Items can be routed to the payment decision module 438. “Exact Pay” rule types address general conditions where a payment is acceptable. Limits such as thresholds are noted in this rule type. “Underpay—Match Sub-Amounts” attempts to match the intent of the customer. “Underpay—Match Sub-Amounts” steps through the list of amount type combinations in order and, if the total of the payment matches the total of the specified amount types within the margin, the rule is used for allocating the payment. “Underpay—Allocate by Biller Policy” allocates as much as possible to the first specified bill amount type, then as much of the remainder as possible to the second bill amount type, continuing until the entire payment is used. “Overpay—Allocate to Sub-Accounts” attempts to match the intent of the customer. It steps through the list of amount type combinations defined in the user interface 410 in order and, if the total of the payment matches the total of the specified amount types within the margin, the rule is used for allocating the payment. There is always a defined percentage or defined maximum amount for the amount type details. The “Overpay—Multiple Periods” rule type matches on multiples of the customer's bill and allows them to make several future payments at once. Maximum Periods must be at least two and can be used to put a cap on the number of payments they can make in advance. In the embodiment shown, the maximum period must be an exact multiple of the payment and will include the maximum number of allowable periods to pay. The “Overpay—Allocate by Policy” rule applies the excess to the specified amount types in sequence according to the defined maximums. A percentage or maximum amount can be defined. For each rule type, an action is designated based on the rule criteria, step 934. These actions are prioritized, so the highest priority action is selected first, step 936. The actions consist of either the transaction being accepted or being sent to the payment decision module 438, step 910. If accepted, step 908, in which case it does not need to be reviewed by the biller 102, the payment is sent to the next step in the process, step 906. If the payment is not accepted, it is sent to the payment decision module 438, step 938, for review by the biller 102. When accepted, the payment continues in the payment processing workflow and is included in the accounts receivable file sent to the biller 102. This is the default state for all rule types except “Simple”. When rejected, the payment is removed from the payment processing workflow and sent to the payment decision module 438, as shown in FIGS. 8a and 8b.

Referring to FIG. 8a, a flowchart shows the payment decision process of the payment decision module 438 in the embodiment of FIGS. 4a and 4b. Payments are processed (usually either as a rejection or deposit and settlement) as determined by the remittance rules, as shown in FIG. 7. However, some payments require a review and decision by a user 102 because the conditions of the payment do not meet any of the remittance rules or because a specific remittance rule dictates that a certain type of payment be reviewed rather than automatically handled. If payments are not automatically handled by the pre-determined remittance rules, they are sent to the payment decision module 438 for a user 102 to review and assign.

When a payment requires review, it can be assigned to a specific user 102 or group for review, step 1004. The remittance rules will dictate which payments are assigned to which users 102 or groups, and these payments are placed in a queue for review by that user 102 or group, step 1006. In some cases, payments do not meet the pre-defined criteria for assignment. In these cases, the payments remain unassigned and go into an unassigned queue for review by the user 102 charged with reviewing unassigned payments, step 1008.

Turning to FIG. 8b, when a user 102 logs in to payment decision module 438, step 1010, the user 102 sees payments requiring a decision in his or her queue. The user 102 selects the first individual payment to review, step 1012, and is presented with a transaction processing screen which gives the user 102 the options available for how to process the payment, step 1014. The user 102 reviews the remittance rule that caused the payment to be assigned for review, step 1016, then determines how the payment should be handled, step 1018. For example, if the account number on the payment is incorrect, thus preventing the payment from being processed, the user 102 can modify or add the correct account number, step 1020. If the payment requires the user 102 to make a decision on how the funds should be disbursed, the user 102 can select the amounts that should be deposited in each account, step 1022. Finally, if the account number and disbursement reviews are complete, the user 102 can decide to either accept or reject the item, step 1024. If accepted, the system 100 checks the payment to ensure that the payment is balanced, step 1026. If it is not balanced, the user 102 is prompted to review disbursement again. If it is balanced, the user 102 assigns a reason for the acceptance or rejection of the payment, step 1028.

Once the payment is either accepted or rejected, the system 100 is updated with the correct transaction status and necessary pocket configuration so each payment goes through the payment processor 304 and ends up in the correct pocket for its disposition, step 1030. The user 102 then selects the next payment from the queue to review.

When items require payment decision, the batch containing those items is held until all items requiring a decision are assigned a decision, step 1034. Once a decision has been assigned, the batch is removed from the Payment Decisioning queue, step 1040, and returned to the normal payment processing workflow, step 1044. If the time period for assigning a decision has expired, step 1036, the in-process items are pulled from the User's queue and the user 102 receives a message stating such, step 1042. Then the batch is removed from the Payment Decisioning queue 1040 and returned to the normal payment processing workflow, step 1044.

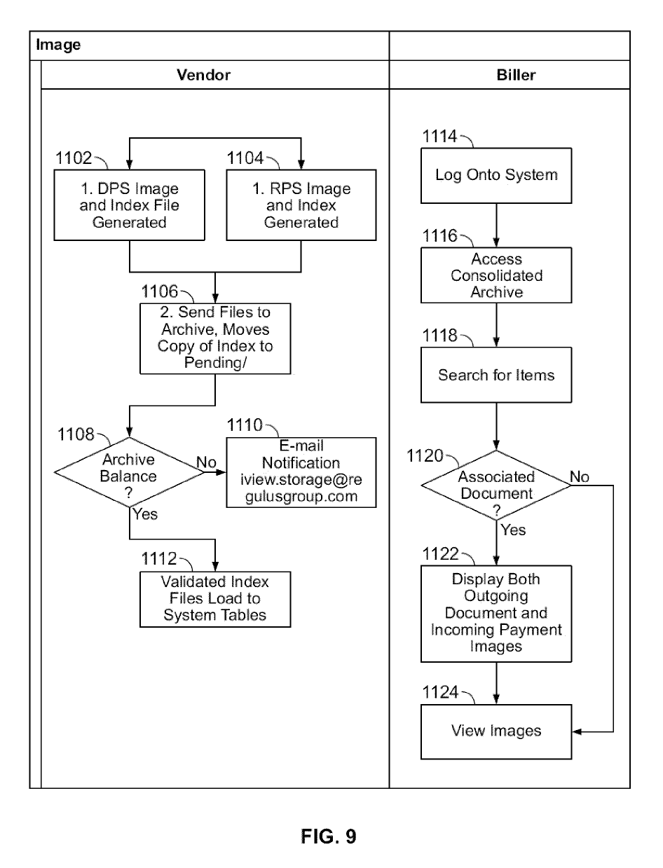

Referring to FIG. 9, a flowchart illustrates the consolidated storage process for consolidating the storage of images within the system 100. The flowchart shows the process for the vendor 102 and for the biller 102. As shown in FIG. 4, the process of printing or creating electronically a billing document 208 for a biller 102, steps 604-622, results in the generation of an image of that billing document 208 or an electronic equivalent for electronic bills. Likewise, an image of the incoming payment or electronic equivalent for electronic payments is generated during the payment processing workflow, steps 628-644. At steps 620 and 642, these billing document 208 and payment images (with the appropriate transaction data, including customer, account information, etc.) are sent to the image database 124. The image database 124 stores, catalogues, indexes and retrieves images and associated account information using various search mechanisms available through the web interface module 410.

The images are created through the bill printing or payment processing workflows of FIG. 4, steps 1102, 1104. Also at steps 1102 and 1104, a list (called an index) of images captured from the bill printing and payment processing is generated containing some associated data, such as account information that the biller 102 needs for identification but that is not included on the bill, related to the bills and payments. The images and indexes are sent to the image database 124, step 1106.

Before being recorded in the image database 124, the system 100 compares the index against the image files 1108. This process determines whether the number of image files as well as the image names and associated data matches the information contained in the index files. If there is a mismatch between the index and the image files, an e-mail or alert is generated to notify the authorized administrator to take action to review and correct the problem, step 1110. If the index matches the image files, the images and the index file are loaded into the master system tables within the image database 124, step 1112. The information stored in the database 124 can be archived after a period of 60 or 90 days, such as by storing to tape or other long-term memory device (e.g., the warehousing database 126).

Once the image and index files are loaded into the master system tables, an authorized user 102 can then call up and view images of billing document 208 or payment from the database 124 or 126. For instance, a biller could view the images of a billing document 208 and the associated payment for that billing document 208 together on the web interface 410 in case a customer complains of making too large of a payment, to see if the billing document 208 was incorrect or if the customer just accidentally overpaid.

To access the image database 124, a biller 102 first logs onto the system 100, step 1114. The system 100 has security measures that require authentication for a biller 102 to access images in the database 124 or 126. Once the biller 102 logs in, the biller 102 can access the database 124 or 126, step 1116, though a graphical interface. The interface allows the biller 102 to search the images in the image database 124 based on a variety of criteria, such as account number, payment amount and/or account holder name, step 1118. If the system 100 finds a match to the search criteria, step 1120, it returns the images for the biller 102 to view on the screen of the Internet interface 104, step 1124. The system 100 can display the bill image, the payment image, or both the outgoing bill and incoming payment images if the database 124 or 126 contains the images for both, step 1122.

As apparent from the foregoing description, according to an exemplary embodiment of the invention, the system 100 provides a Web-based interface 104 that enables users 102 to: generate rules to affect the printing of billing documents 208; identify and select individual billing documents 208 or groups of billing documents 208 to pull from printing or route to a specific mailing location; review electronically and update selected individual billing documents 208 or groups of billing documents 208 with a disposition status; establish rules to affect payment processing; view and approve or deny payments not automatically processed or determine specific deposit instructions; and retrieve stored images related to billing documents 208 or payments from a single repository and view those images through a single interface 104. These features provide better ease-of-use and control compared to systems that separately print billing documents 208 and process payments. The system 100 also allows users 102 to monitor accounts via billing documents 208 and remittances. The system 100 matches billing documents 208 with remittances, and thus, the system 100 provides status of payments and amounts outstanding. The system 100 can match one or more remittances with one or more billing documents 208 so that accounts can be tracked over one or more billing cycles. The system 100 can deliver an AR file that includes electronic data, the printed billing documents 208, or both. When the AR file includes electronic data and printed data, the system 100 matches corresponding electronic and print data. The system 100 enables the user 102 to create and to implement a campaign by allowing the user 102 to control the printing of the billing document 208. Also, by controlling the printing of billing documents 208, the system 100 allows the user 102 to suppress printing of one or more billing documents 208 and send the billing documents 20 electronically. The system 100 makes billing quicker, easier, and less expensive for the biller or the vendor; provides an improved customer interface; and provides the biller or the vendor with more control over billing document printing and payment processing. The system 100 can be customized for each user based on, for instance, the use of various account or customer codes. For example, the global print rules and statement-specific content rules for one or more billing documents 208 can be retrieved based on the account or customer code associated with each user 102.

The foregoing description and drawings should be considered as illustrative only of the principles of the invention. The invention may be configured in a variety of manners and is not intended to be limited by the described embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A system comprising:
one or more processors for processing billing documents and for processing payments, and
one or more databases in communication with said one or more processors, the one or more databases storing information generated by said one or more processors.

2. The system of claim 1, wherein said one or more processors control the production of billing documents and the processing of payments together through a single software platform, utilizing common databases and components.

3. The system of claim 1, wherein said one or more processors allow a biller to setup rules governing what content is printed on the billing documents with no custom programming required.

4. The system of claim 3, wherein said one or more processors further allow the biller to customize those rules to apply to groups of bills or to individual bills as decided upon by the biller.

5. The system of claim 1, wherein said one or more processors provide setup rules governing the electronic creation, printing, and handling of billing documents with no custom programming required, and to customize those rules to apply to groups of bills or to individual bills as decided upon by the biller.

6. The system of claim 1, wherein said one or more processors enable billers to establish rules governing how payments are handled, processed and deposited with no custom programming required, and to customize those rules to apply to groups of payments or to individual payments as decided upon by the biller.

7. The system of claim 1, wherein said one or more processors enable billers to view images of payments and coupons online, decide how the payment should be handled and deposited, enter decisions through a GUI, and have that decision carried out in the payment processing workflow.

8. The system of claim 1, wherein said one or more central repositories store images of billing documents and remittance coupons and checks and enable a user of the system to access and view the statements and remittances together, on a single screen.

9. The system of claim 1, wherein software for implementing the processes in claims 1-8 controls the hardware and workflow processes required for billing statement printing and remittance payment processing.

10. A computer program product for enabling a computer system to process billing documents and payments, the computer system having a computer readable storage medium bearing software instructions, the computer program product having software instructions for enabling the computer system to perform predetermined operations, the predetermined operations including:
providing print rules that control the production of billing documents;
providing remittance rules that control processing of the payments; and
storing images related to the billing documents and the payments.

11. A computer program product according to claim 10, wherein the predetermined operations further comprise communicating with a printing hardware that prints the billing documents.

12. A computer program product according to claim 10, wherein the predetermined operations further comprise communicating with a payment processor that processes the payments.

13. A computer program product according to claim 10, wherein the predetermined operations further comprise applying the print rules to all billing documents.

14. A computer program product according to claim 10, wherein the predetermined operations further comprise applying the print rules to a portion of the billing documents.

15. A computer program product according to claim 10, wherein the predetermined operations further comprise applying the remittance rules to all payments.

16. A computer program product according to claim 10, wherein the predetermined operations further comprise applying the remittance rules to a portion of the payments.

17. A computer program product according to claim 10, wherein the software instructions further comprise:
a layer; and
a software component disposed in the layer.

18. A computer program product according to claim 10, wherein the software instructions further comprise:
a presentation layer;
an application layer in communication with the presentation layer;
a database layer in communication with the application layer and the presentation layer;
software components disposed in the presentation layer, the application layer, and the database layer.

19. A computer program product for enabling a computer system to process billing documents and payments, the computer system having a computer readable storage medium bearing software instructions, the computer program product having software instructions for enabling the computer system to perform predetermined operation, the predetermined operations including:
communicating through an Internet interface with a system in communication with printing hardware and a payment processor;
providing billing data to the system in communication with the printing hardware and the payment processor;
establishing print rules that control the production of billing documents by the printing hardware; and
establishing remittance rules that control processing of the payments by the payment processor.

20. A computer program according to claim 19, wherein the predetermined operations further comprise retrieving through the Internet interface images related to the billing documents and payments.
